(19) United States
(12) Patent Application Publication
(10) Pub. No.: US 2024/0250543 A1
(43) Pub. Date: Jul. 25, 2024

(54) QUASI-LOAD FOLLOWING (Q-LF) HIGH EFFICIENCY FAULT TOLERANT HYBRID ELECTRIC POWER SYSTEM CONTROL METHOD

(71) Applicant: NORTHROP GRUMMAN SYSTEMS CORPORATION, FALLS CHURCH, VA (US)

(72) Inventors: Christopher A. Harris, Falls Church, VA (US); Jeffrey A. Knowles, Yorba Linda, CA (US)

(21) Appl. No.: 18/158,200

(22) Filed: Jan. 23, 2023

(51) Int. Cl. H02J 7/00

(52) U.S. Cl. CPC H02J 7/0047; H02J 7/00714; H02J 7/007182; H02J 2310/44

(57) ABSTRACT

An electric propulsion power system a power plant providing power to a bus, a load drawing power from the bus, a battery providing power to and drawing power from the bus. The power system also includes a control system for controlling the amount of power that the power plant provides to the bus, the amount of power that the battery provides to and draws from the bus in response to the load drawing power from the bus over time. The control system calculates a moving time-average current value over a predetermined time window using the instantaneous current measurements, determines a delta current value as the difference between a current charge/discharge limit of the battery and the moving time-average current value and determines if additional power from the power plant to the bus will be provided and a rate of current in the discharge mode or the charge mode.

### GOVERNMENT CLAUSE

This invention was made with Government support under Contract No. FA8650-17-D-2719 awarded by DARPA. The Government has certain rights in this invention.

### BACKGROUND

### Field

This disclosure relates generally to an electric propulsion power system and, more particularly, to an electric propulsion power system that operates a quasi-load following supervisory control algorithm that controls the amount of power provided by a power plant to a DC bus and causes a battery unit to discharge to provide power to the bus and to charge to remove power from the bus so that the power delivered by the power plant to operate loads can be less responsive than what would be required with a load following scheme.

### Discussion of the Related Art

Electric propulsion power systems are known in the art for various applications, such as power generation for turbojet or turboprop aircraft and other vehicles. Demand for power from these systems changes over time as the vehicle is being operated, which needs to be quickly met by the system. Two general approaches currently exist in the art for providing the desired power to a particular load, namely, voltage following and load following. For voltage following, multiple smaller power sources in a hybrid electric power generation system can be used, since the power of any one power source simply switched on or off, can usually be sized to be within the current charging limitations of a given battery system. For load following, the turbomachinery or other mechanical power source that spins the generator or alternator must very quickly deliver the rotational speeds and power required, and thus imposes highly demanding transient requirements on the system, and will operate the system typically farther off the operating line of the engine, and hence less efficiently. Further, neither of these approaches handles fault tolerance very well including sudden removal of loads from the bus in the case of a component failure, and may impose unwanted electrical loads on the entire system.

There is a need in the art for a robust fault-tolerant power generation system that can be tuned to operate with many types of engines and energy storage systems, and that can accommodate complex propulsion architectures with significant variation with a slow enough response to allow the engine to operate at the highest efficiency, but fast enough to protect batteries from over-current.

### SUMMARY

The following discussion discloses and describes an electric propulsion power system including a DC bus, at least one power plant providing power to the bus, at least one load drawing power from the bus, a battery unit coupled to the bus and being configured to provide power to the bus in a discharge mode and draw power from the bus in a charge mode, a voltage sensor for measuring voltage on the bus, and a current sensor for measuring instantaneous current provided to the battery unit from the bus and provided from the battery unit to the bus. The power system also includes a control system for controlling the amount of power that the at least one power plant provides to the bus, the amount of power that the battery unit provides to the bus and the amount of power that the battery unit draws from the bus in response to the at least one load drawing power from the bus over time. The control system calculates a moving time-average current value over a predetermined time window using the instantaneous current measurements, determines a delta current value as the difference between a current charge/discharge limit of the battery unit and the moving time-average current value and determines if additional power from the at least one power plant to the DC bus will be provided and a rate of current in the discharge mode or the charge mode based on the delta current value.

Additional features of the disclosure will become apparent from the following description and appended claims, taken in conjunction with the accompanying drawings.

### BRIEF DESCRIPTION OF THE DRAWINGS

FIG. 1 is a graph with time in seconds on the horizontal axis and power in kW on the vertical axis showing the changing power requirement of an aircraft load over time and the power delivered by a power plant to meet the power requirement during aircraft flight;

FIG. 2 is a block diagram of an electric propulsion power system that has particular application for use on turbojet or turboprop aircraft; and

FIG. 3 is a flow chart diagram showing the operation of a quasi-load following supervisory control algorithm for the power system shown in FIG. 2.

### DETAILED DESCRIPTION OF THE EMBODIMENTS

The following discussion of the embodiments of the disclosure directed to an electric propulsion power system that operates a quasi-load following supervisory control algorithm that controls the amount of power provided by a power plant to a DC bus and causes a battery unit to discharge to provide power to the bus and to charge to remove power from the bus so that the power delivered by the power plant to operate loads can be less responsive than what would be required with a load following scheme is merely exemplary in nature, and is in no way intended to limit the disclosure or its applications or uses.

A power generation control system is disclosed that includes both software and hardware components for controlling the generation of electrical power for hybrid-electric aircraft or other applications. The control system allows for the best possible efficiency from a turbo-electric powered hybrid electric aircraft, without imposing significant cost and schedule impacts to the development of the power system in terms of a sufficiently fast transient response. The control system allows load following of the very rapidly changing electrical current loads on the control system, while maintaining electrical charging currents within the limits of an energy storage system, while being tunable to work with a wide range of potential energy storage systems and designs. The control system can also robustly handle failure modes that will present step load changes on the bus without requiring extensive failure mode specific logic or hardware development.

As will be discussed, the power generation control system includes a power plant, such as a turbine engine, and an energy storage system, such as a battery system, that is coupled to an electrical power bus that can both provide and accept electrical current. The control system further includes load sensors on the energy storage system that measure instantaneous electrical current, and a general hardware controller, which can be off-the-shelf and has appropriate I/O for the current sensor signals. The control system employs a time-averaging process that calculates a moving-average electrical current, and an error calculation that subtracts the moving-average electrical current from the battery current limit to determine a current error value that will be minimized by the controller. The control system also includes a bus voltage sensor that estimates the power differential required to adjust an engine speed command, and an engine control unit (ECU) that will accept or may internally calculate the controller error to determine a speed at which to command the power plant in order to provide sufficient power to minimize the electrical current error based on an engine power output differential calculated by the ECU and turned into a new power lever angle (PLA) command that will increase or decrease the power output to minimize the current error.

Also disclosed is a method for controlling the generation of electrical power from a turbine or other shaft power generation methods that allows for a moderately slow response on the mechanical (turbine) system to allow it to operate at optimal efficiencies even when in transient operating states, which will also offer robust failure-tolerant response to multiple loads while protecting the energy storage system. The method includes measuring electrical currents on the energy storage system, time-averaging those currents in a vector form to generate individually accessible current loads to be able to control to, and then generation of a control error for the controller in the form of the difference between the moving time-average electrical current(s) and the limit current to the energy storage system to be able to maximize charging rates and system performance without overcharging the energy storage system. The control system can use either static (constant) pre-set values of limit currents, or is flexible to accommodate real-time limit currents that may be, for example, determined by a battery management system (BMS) based on real-time battery physical conditions.

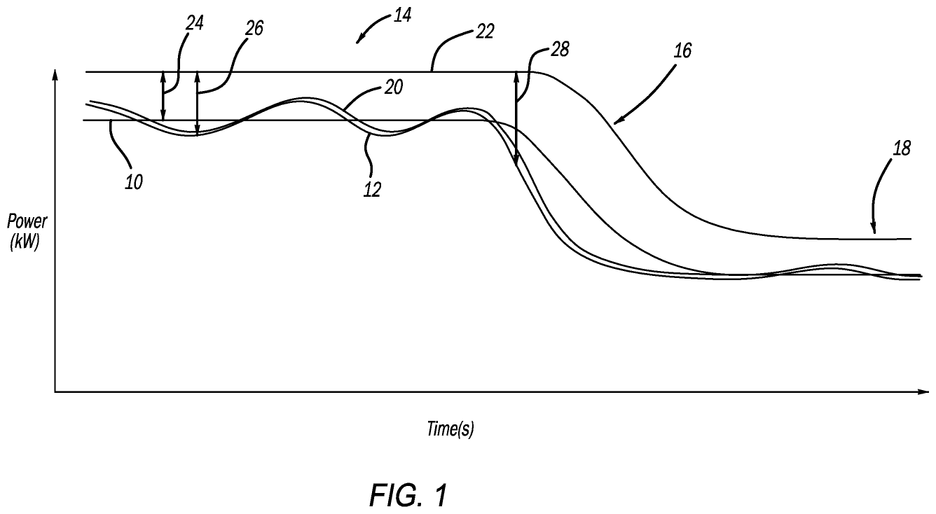

FIG. 1 is a graph with time in seconds on the horizontal axis and power in kW on the vertical axis showing the changing power requirement of an aircraft load over time and the power delivered by a power plant to meet the power requirement during aircraft flight over about a ten second time period. Graph line 10 is the time-averaged power required for powering the propulsion loads to propel the aircraft and is calculated by, for example, averaging the power requirement over a moving time window. It is noted that additional power would be required to operate all of the loads on the aircraft, but for simplicity sake, only the power required to propel the aircraft is being discussed. Graph line 12 is the instantaneous power required for powering the propulsion loads, which fluctuates relative to the line 10 because of aircraft control behavior and other real-world factors. The graph shows a transition from a high power flight segment 14, such as during aircraft cruising at altitude, through a transition segment 16 to a low power flight segment 18, such as during aircraft descent. For proper aircraft flight, the power needed to meet the changing power requirements of the line 12 during aircraft flight needs to be met very quickly. Current propulsion systems may employ a load following algorithm and process to do that, which will generate a load-following power output line 20 from the power plant. However, such a load following algorithm requires various sensors and components that increase the size, weight and cost of the system.

As discussed above, this disclosure proposes an energy storage system and a quasi-load following supervisory control scheme that compensates for the power changes that are needed to power the propulsion loads. The power plant is controlled to output power along power line 22, which doesn't quickly react to power fluctuations along the line 12 as was done to accommodate the load following line 20. The energy storage system is charged or discharged some amount as the power requirement changes to quickly meet the demand. Line 24 represents the average battery system charge/discharge current B̅C̅D̅ and line 26 represents the instantaneous battery system charge/discharge current BCD, or BCDI. During the transition segment 16, the amount of power that the power plant puts out reacts slowly to the decrease in power requirement. For the example shown in FIG. 1 the power line 22 is always above the required power line 12, so the battery system is always in a state of charge. Once the charge limits of the battery system are met, the power output of the power plant will be reduced where the line 22 will be below the line 12, where the battery system would be in a state of discharge.

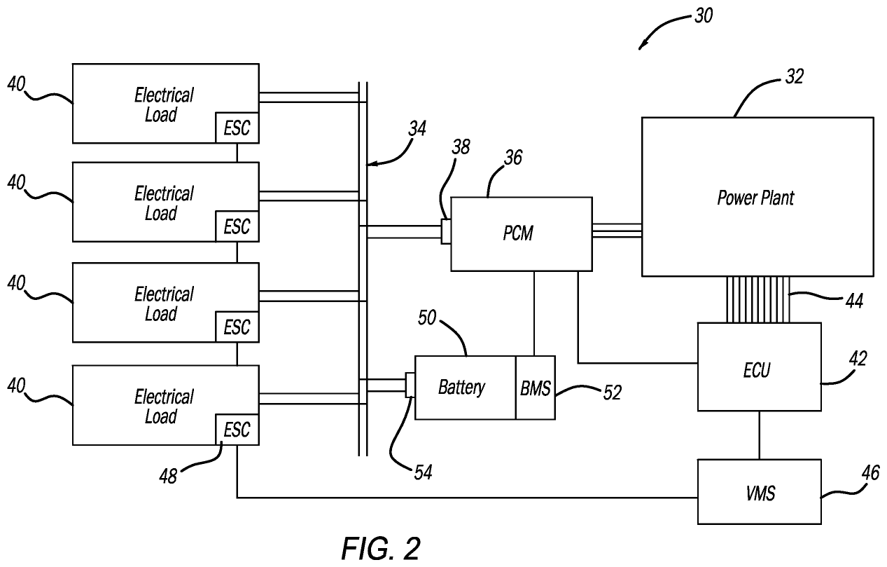

FIG. 2 is a block diagram of an electric propulsion power system 30 that has particular application for use on a turbojet or turboprop aircraft, but is applicable for other electric power systems where high performance and reliability is required. The system 30 includes a power plant 32, such as a turbo-alternator, that provides electrical power on a high voltage (HV) direct current (DC) bus 34 through a power control module (PCM) 36, where the PCM 36 controls the speed and torque of the power plant 32. A voltage sensor 38 measures the voltage across the positive and negative rails of the bus 34, and provides the measured voltage to the PCM 36 or other suitable device in the system 30, where the sensor 38 can be provided at any suitable location. The power plant 32 can be any suitable power source for the purposes described herein, such as a rotary engine or a turbine engine. Although a single power plant is shown in the system 30, other system designs may employ multiple power plants. A number of electrical loads 40 draw power from the bus 34, and can be the same type or different types of loads. For the aircraft example being discussed herein, the loads 40 can be electric propulsors. The system 30 also includes an ECU 42 that controls the fuel rate to the power plant 32 to maintain the best efficiency to deliver the power commanded by the PCM 36, where the ECU 42 receives sensor signals 44 from sensors (not shown) in the power plant 32. A vehicle management system (VMS) 46 controls an electronic speed controller (ESC) 48 in each of the loads 40 to increase or decrease the power output of the system 30, such as changes in throttle commands, which causes the loads 40 to increase or decrease the power they pull from the bus 34. The VMS 46 also provides commands to the ECU 42, such as enable or disable the power plant 32.

The system 30 also includes a battery unit 50 that is coupled to the bus 34 and includes and is controlled by a BMS 52 that controls the charge and discharge rate of the battery unit 50, where the battery unit 50 includes a current sensor 54 that measures the instantaneous current BCDI provided to the bus 34 from the battery unit 50 and the instantaneous current BCDI provided from the bus 34 to charge the battery unit 50. The battery unit 50 is intended to represent any number of batteries or battery modules suitable for a certain system and the current sensor 54 is intended to represent any suitable device or algorithm that measures instantaneous current into and out of the battery unit 50. The power plant 32, the PCM 36, the ECU 42 and the battery unit 50 are controlled by a quasi-load following supervisory control algorithm that controls the amount of power provided by the power plant 32 and causes the battery unit 50 to discharge to provide power to the bus 34 and to charge to remove power from the bus 34 based on a supervisory control scheme so that the power delivered by the power plant 32 to operate the loads 40 can be less responsive than what would be required with a load following scheme.

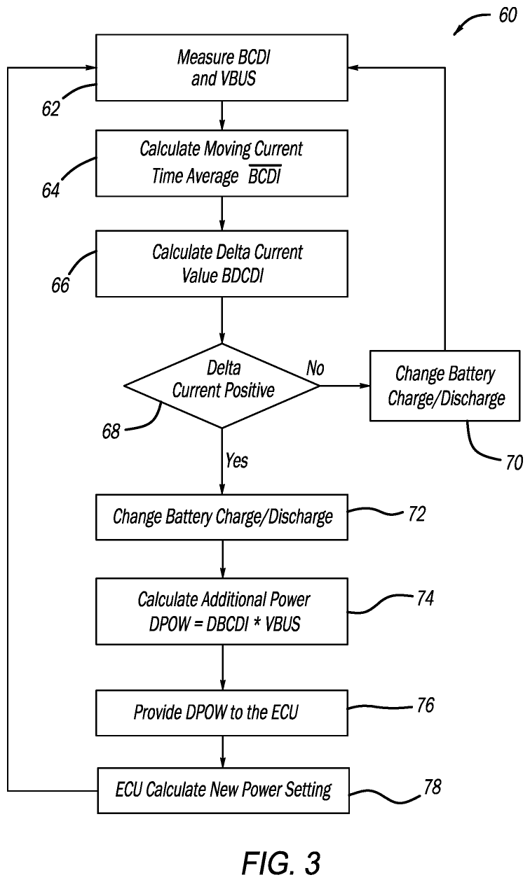

FIG. 3 is a flow chart diagram 60 showing the operation of the quasi-load following supervisory control algorithm referred to above, which may be performed in the PCM 36. If the bus voltage VBUS is below a predetermined upper limit, then the power plant 32 is enabled, and if the bus voltage VBUS is above the upper limit the power plant 32 is disabled. The instantaneous current BCDI and the bus voltage VBUS are constantly being measured at box 62 and the instantaneous current BCDI is used to calculate the moving current time-average B̅C̅D̅I̅ over a moving sample window at box 64, where the moving current time-average B̅C̅D̅I̅ provides a set-point for the power plant 32 to respond to and where the time length of the window can be tuned for any suitable power plant and/or application. A delta current value DBCDI is calculated at box 66 as the difference between the charge/discharge limit BCDI_{LIMIT} of the battery unit 50 and the current time-average B̅C̅D̅I̅. The algorithm determines whether the delta current value DBCDI is positive at decision diamond 68, and if not, changes the battery charge or discharge to the bus 34 as necessary at box 70. If the delta current value DBCDI is positive at the decision diamond 68, then the algorithm also changes the battery charge or discharge to the bus 34 as necessary at box 72 and calculates the additional power DPOW required to meet the desired power at box 74 by multiplying the delta current value DBCDI by the measured bus voltage VBUS.

The PCM 36 provides an additional power DPOW signal to the ECU 42 at box 76 and the ECU 42 adds the additional power DPOW to the current power setting POW at box 78 and provides a command for the amount of fuel required to the power plant 32 to provide the additional power. For a given altitude and temperature condition, the throttle setting of the aircraft identified as a power lever angle (PLA) is determined, where the PLA is a function of POW+DPOW. The new PLA is set up to a 100% maximum, where if POW+DPOW exceeds the maximum engine power, then the new PLA is set to 100%. The normal engine+generator inner control loop takes over to adjust the power plant throttle at the best engine transient rate capability, while maintaining a high turbine inlet temperature (TIT). The generator sets a new speed target and starts to ramp up the generator speed. The engine responds by maintaining fuel rate control while engine speed increases via torque adjustments on the generator to maintain TIT and providing the highest efficiency response possible from the power plant 32.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. An electric propulsion power system comprising:
a DC bus;
at least one power plant providing power to the bus;
at least one load drawing power from the bus;
a battery unit coupled to the bus and being configured to provide power to the bus in a discharge mode and draw power from the bus in a charge mode;
a voltage sensor for measuring voltage on the bus;
a current sensor for measuring instantaneous current provided to the battery unit from the bus and provided from the battery unit to the bus; and
a control system for controlling the amount of power that the at least one power plant provides to the bus, the amount of power that the battery unit provides to the bus and the amount of power that the battery unit draws from the bus in response to the at least one load drawing power from the bus over time, said control system calculating a moving time-average current value over a predetermined time window using the instantaneous current measurements, determining a delta current value as the difference between a current charge/discharge limit of the battery unit and the moving time-average current value and determining if additional power from the at least one power plant to the DC bus will be provided and a rate of current in the discharge mode or the charge mode based on the delta current value.

2. The power system according to claim 1 wherein the control system determines that additional power is required if the delta current value is positive and determines the additional power is the delta current value minus the measured bus voltage.

3. The power system according to claim 2 wherein the control system determines the power provided to the bus from the at least one power plant as the additional power plus the current power setting.

4. The power system according to claim 3 wherein the control system includes a power control module (PCM) and an engine control unit (ECU), said PCM provides an additional power signal to the ECU and the ECU adds the additional power to the current power setting.

5. The power system according to claim 1 wherein the battery unit includes a battery management system (BSM) that controls the charge/discharge rate of the battery unit.

6. The power system according to claim 1 wherein if the bus voltage is below a predetermined upper limit, then the at least one power plant is enabled, and if the bus voltage is above the upper limit the at least one power plant is disabled.

7. The power system according to claim 1 wherein the at least one power plant is a plurality of power plants and the at least one load is a plurality of loads.

8. The power system according to claim 1 wherein the power system is on an aircraft, the at least one load is a plurality of electric aircraft propulsors and the at least one power plant is a turbo-alternator.

9. An electric propulsion power system on an aircraft, said system comprising:
a DC bus;
a turbo-alternator providing power to the bus;
a plurality of electric aircraft propulsors drawing power from the bus;
a battery unit coupled to the bus and being configured to provide power to the bus in a discharge mode and draw power from the bus in a charge mode;
a voltage sensor for measuring voltage on the bus;
a current sensor for measuring instantaneous current provided to the battery unit from the bus and provided from the battery unit to the bus;
an electronic control unit (ECU) setting an amount of fuel provided to the turbo-alternator; and
a power control module (PCM) for controlling the amount of power that the turbo-alternator provides to the bus, the amount of power that the battery unit provides to the bus and the amount of power that the battery unit draws from the bus in response to the turbo-alternator drawing power from the bus over time, said PCM calculating a moving time-average current value over a predetermined time window using the instantaneous current measurements, determining a delta current value as the difference between a current charge/discharge limit of the battery unit and the moving time-average current value and determining if additional power from the turbo-alternator to the DC bus will be provided and a rate of current in the discharge mode or the charge mode based on the delta current value.

10. The power system according to claim 9 wherein the PCM determines that additional power is required if the delta current value is positive and determines the additional power is the delta current value minus the measured bus voltage.

11. The power system according to claim 10 wherein the PCM determines the power provided to the bus from the turbo-alternator as the additional power plus the current power setting.

12. The power system according to claim 9 wherein if the bus voltage is below a predetermined upper limit, then the turbo-alternator is enabled, and if the bus voltage is above the upper limit the turbo-alternator is disabled.

13. A method for operating a quasi-load following supervisory control algorithm in an electric propulsion power system that controls the amount of power provided by a power plant to a DC bus and causes a battery unit to discharge to provide power to the bus and to charge to remove power from the bus in response to one or more loads drawing power from the bus over time, said method comprising:
measuring voltage on the bus;
measuring instantaneous current provided to the battery unit from the bus and provided from the battery unit to the bus;
calculating a moving time-average current value over a predetermined time window using the instantaneous current measurements;
determining a delta current value as the difference between a current charge/discharge limit of the battery unit and the moving time-average current value; and
determining if additional power from the power plant to the DC bus will be provided and a rate of current in the discharge mode or the charge mode based on the delta current value.

14. The method according to claim 13 further comprising determining that additional power is required if the delta current value is positive and determining that the additional power is the delta current value minus the measured bus voltage.

15. The method according to claim 14 further comprising determining the power provided to the bus from the power plant as the additional power plus the current power setting.

16. The method according to claim 13 wherein if the bus voltage is below a predetermined upper limit, then the power plant is enabled, and if the bus voltage is above the upper limit the power plant is disabled.

17. The method according to claim 13 wherein the power system is on an aircraft, the one or more loads is a plurality of electric aircraft propulsors and the power plant is a turbo-alternator.
